(19) United States
(12) Patent Application Publication
(10) Pub. No.: US 2022/0042454 A1
(43) Pub. Date: Feb. 10, 2022

(54) NACELLE AIR INTAKE WITH AN ACOUSTIC PANEL

(71) Applicant: Safran Nacelles, GONFREVILLE L'ORCHER (FR)

(72) Inventors: Pierre CARUEL, MOISSY CRAMAYEL (FR); Bertrand DESJOYEAUX, MOISSY CRAMAYEL (FR); Bertrand LEROYER, MOISSY CRAMAYEL (FR); Marc VERSAEVEL, MOISSY CRAMAYEL (FR); Laurent Georges VALLEROY, MOISSY CRAMAYEL (FR)

(73) Assignee: Safran Nacelles, GONFREVILLE L'ORCHER (FR)

(21) Appl. No.: 17/510,609

(22) Filed: Oct. 26, 2021

Related U.S. Application Data
(63) Continuation of application No. PCT/EP2020/060989, filed on Apr. 20, 2020.

(30) Foreign Application Priority Data
Apr. 26, 2019 (FR) 19/04428

(51) Int. Cl. F02C 7/045

(52) U.S. Cl. CPC F02C 7/045; F05D 2230/237; F05D 2250/191; F05D 2260/96; F05D 2250/324

(57) ABSTRACT

An air intake of a turbojet engine nacelle includes an annular structure including an outer fairing defining an aerodynamic outer surface and an inner fairing defining an aerodynamic inner surface. The outer and inner fairings are connected upstream by an air intake lip forming a leading edge. The inner fairing includes an outer skin fixed to the air intake lip by an upstream fixation flange, and the outer skin is configured to be fixed to an outer fan casing by a downstream fixation flange. The air intake includes at least one independent acoustic panel attached to the outer skin and which includes a perforated acoustic skin and a cellular core.

### CROSS-REFERENCE TO RELATED APPLICATIONS

This application is a continuation of International Application No. PCT/EP2020/060989, filed on Apr. 20, 2020, which claims priority to and the benefit of FR 19/04428, filed on Apr. 26, 2019. The disclosures of the above applications are incorporated herein by reference.

### FIELD

The present disclosure relates to a nacelle air intake of a turbomachine such as a turbojet engine or a turboprop of an aircraft.

### BACKGROUND

The statements in this section merely provide background information related to the present disclosure and may not constitute prior art.

An aircraft is propelled by one or more propulsion units each comprising a turbojet engine/turboprop housed within a tubular nacelle. Each propulsion unit is attached to the aircraft by a pylon generally located underneath a wing or at the level of the fuselage.

A nacelle generally has a tubular structure comprising an upstream section forming an air intake upstream of the engine, a middle section configured to surround a fan of the turbojet engine, a downstream section adapted to accommodate a thrust reversal device and configured to surround the combustion chamber of the turbojet engine, and generally terminates in an ejection nozzle whose outlet is located downstream of the turbojet engine.

The air intake is configured to improve air capture for feeding the fan of the turbojet engine over the entirety of the flight envelope and to channel air towards the fan.

The air intake comprises an air intake lip forming a leading edge, attached on an annular structure.

The annular structure comprises an outer fairing providing the outer aerodynamic continuity of the nacelle and an inner fairing providing the inner aerodynamic continuity of the nacelle, in particular with the fan outer casing at the level of the middle section. The air intake lip provides a junction between these two fairings upstream.

The inner fairing of the air intake is exposed to an air stream and is located proximate to the blades of the fan. It therefore contributes to the transmission of the noise originating from the turbojet engine towards the outside of the aircraft.

Also, it is known to equip the inner fairing of the air intake of the nacelle with an acoustic panel in order to attenuate the transmission of the noise generated by the turbojet engine.

Typically, the acoustic panel includes a perforated acoustic skin and a cellular core which is assembled on the acoustic skin.

The cellular core includes a plurality of acoustic cells, forming Helmholtz resonators, which are separated from each other by peripheral partitions.

The perforated skin is directed towards the noise emitting area, so that the acoustic waves can penetrate through the openings of the perforated skin into the acoustic cells. The acoustic energy is dissipated by visco-thermal effect within the acoustic cells.

The cellular core of the acoustic panel may include one single cell thickness, or two thicknesses separated by a micro-perforated septum to improve the acoustic performance of the panel.

Besides their acoustic attenuation function, these panels provide two other functions:

an aerodynamic function: the perforated skin, in contact with the air and flow streams flowing through the turbojet engine and the nacelle channels the stream and should disturb these flows as little as possible; and

a load-path structural function: the acoustic panel is capable of taking up some of the loads to which the nacelle is subjected.

Maintenance and repair of the acoustic panels, for example in the event of damage caused by bird strikes, intake of foreign bodies, etc., is difficult.

Furthermore, aerodynamic losses might be caused by the perforations of the acoustic skin, which disturb the proper operation of the air intake, and which are reflected by a decrease in engine performance. In order to reduce these aerodynamic losses, the section of these perforations should be reduced as much as possible.

The treatment surface of the acoustic panels cannot be used as much in comparison with the available surface of the air intake, the acoustic panels being generally reinforced with structural reinforcements to provide for load transfer when an acoustic perforation is ineffective or even impossible.

Manufacturing of these acoustic panels, in particular those formed by two cell thicknesses, takes additional manufacturing steps and is generally more expensive.

Further, locating fan blades in the short air intake architectures that have a generally frustoconical geometry is difficult. This architecture is beneficial from an aerodynamic perspective, but it makes the blade deposition complex since an axial translational displacement of a fan blade towards the air intake lip implies an interference with the air intake.

### SUMMARY

This section provides a general summary of the disclosure and is not a comprehensive disclosure of its full scope or all of its features.

The present disclosure provides an air intake of a turbojet engine nacelle that comprises an annular structure including an outer fairing defining an outer aerodynamic surface and an inner fairing defining an inner aerodynamic surface. The outer and inner fairings are connected upstream by an air intake lip forming a leading edge, said inner fairing comprising an outer skin fastened to the air intake lip by an upstream fastening flange, said outer skin being configured to be fastened to a fan outer casing by a downstream fastening flange. The air intake comprises at least one independent acoustic panel attached to the outer skin and comprising a perforated acoustic skin and a cellular core.

According to another aspect, the present disclosure concerns an air intake of a turbojet engine nacelle comprising an annular structure including an outer fairing defining an outer aerodynamic surface and an inner fairing defining an inner aerodynamic surface. The outer and inner fairings are connected upstream by an air intake lip forming a leading edge, said inner fairing comprising an outer skin fastened to the air intake lip by an upstream fastening flange, said outer skin is configured to be fastened to a fan outer casing by a downstream fastening flange. The air intake comprises at least two independent acoustic panels attached to the outer skin and comprising a perforated acoustic skin and a cellular core, said at least two acoustic panels being adjacent and connected together by overlapping. By overlapping, it should be understood that at least one of the panels is partially superimposed with the other one. The overlapping facilitates the assembly of the acoustic panels, and thus the manufacture of the air intake.

By the term “connected,” it should be understood that mechanical elements are integral with one another or that mechanical elements are assembled therebetween by any suitable fastening means, such as screws, rivets, welding, or gluing, among others.

By attached independent acoustic panel, it should be understood an acoustic panel manufactured separately form the air intake and which is assembled afterwards on the outer skin of the air intake, operations of maintenance and repair of the acoustic panels are simplified.

Thus, the acoustic panel is non-structural, meaning that has a stiffness significantly lower than that of the inner fairing of the air intake to which it is assembled so as to limit the loads transmitted thereby.

Moreover, the attached acoustic panel allows for improving and controlling the making of the perforations in the acoustic skin of the panel before assembly thereof on the air intake and thus making perforations with a very small section so as to limit aerodynamic losses and improve the acoustic operation. This also allows using new materials for making these non-structural acoustic panels.

According to other aspects, the air intake of the present disclosure includes one or more of the following optional features which may be considered separately or according to any possible combination.

According to one feature, the upstream fastening flange is integral with the outer skin. This allows reducing the production costs of the air intake and reducing its mass.

According to one feature, the upstream fastening flange forms an angle in the range of 90° with the outer skin.

According to one form, the outer skin is made of a composite material.

According to another form, the acoustic panel is removably attached to the outer skin.

According to a further form, the acoustic panel is made of a metallic material.

According to yet another form, the cellular core is fastened to the perforated acoustic skin by brazing.

According to still a further form, the air intake comprises at least two adjacent acoustic panels, the acoustic panels being attached to the outer skin and connected together by juxtaposition.

According to another form, the air intake comprises at least two adjacent acoustic panels, the acoustic panels being attached to the outer skin and connected together by overlapping.

According to yet a further form, at least one of the acoustic panels comprises an overlapping strip configured to be superimposed with the adjacent acoustic panel.

In one aspect of the present disclosure, the air intake comprises at least one movable hatch arranged at the level of the annular structure.

The hatch is movable between a closed position in which the hatch is flush with the outer fairing of the annular structure and an open position in which the hatch opens access to the acoustic panel. For example, the movable hatches consist of sliding or pivoting hatches or of hatches adapted to be removed from the annular structure of the air intake.

According to another aspect, the present disclosure relates to a nacelle comprising an air intake as described above.

According to another aspect, the present disclosure relates to a propulsion unit comprising an air intake as described above and a fan comprising a plurality of fan blades. The outer skin of the air intake on which said at least one acoustic panel is attached has a shape diverging from the air intake lip up to the fan blades and the propulsion unit has a radial clearance between the outer skin and the fan blades formed by a setback of at least one acoustic panel.

According to another aspect, the present disclosure relates to a method for depositing a fan blade of a propulsion unit comprising an air intake as described above and a plurality of fan blades, the method comprising:

depositing at least one independent acoustic panel attached to the outer skin so as to form a radial clearance; and

translating a fan blade to be deposited according to an axial displacement in the direction of the air intake lip allowed by the radial clearance.

According to one form of the present disclosure, the method further comprises a step of rotating the fan so as to position a fan blade to be deposited opposite the deposited acoustic panel.

According to another form of the present disclosure, the acoustic panel is attached to the outer skin by fastening flanges and the method further comprises removing a movable hatch from an annular structure to access the fastening flanges of the acoustic panel.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a schematic representation in longitudinal section of a nacelle air intake according to the present disclosure;

FIG. 2 is a further schematic representation in longitudinal section of the nacelle air intake according to the present disclosure;

FIG. 3 is a schematic representation in cross-section of a partial view of the air intake comprising several acoustic panels according to the present disclosure;

FIG. 4 is an enlarged view of the acoustic panels according to the present disclosure;

FIG. 5 is another enlarged view of the acoustic panels according to the present disclosure;

FIG. 6 is a representation of a nacelle air intake according to the prior art;

FIG. 7 is a schematic representation of a deposition of a fan blade according to the present disclosure;

FIG. 8 is a schematic representation of a deposition of a fan blade according to the present disclosure;

FIG. 9 is a schematic representation of an air intake according to a feature of the present disclosure;

FIG. 10 is a schematic representation of an air intake according to another feature of the present disclosure; and

FIG. 11 is a schematic representation in longitudinal section of a nacelle air intake according to a feature of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

The expressions “upstream” and “front” will be used interchangeably to refer to the upstream of the air intake, and the expressions “downstream” and “rear” will be used interchangeably to refer to the downstream of the air intake.

The expressions “upstream” and “downstream” refer to the direction of the air flow coming in and out of a nacelle.

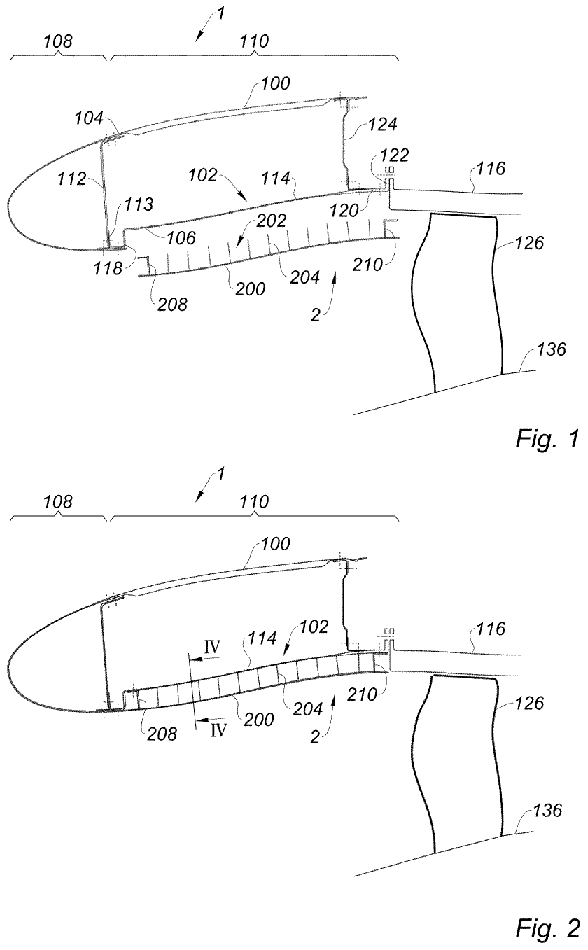

FIG. 1 illustrates an air intake 1 of a turbomachine nacelle. The air intake comprises an air intake lip 108 and an annular structure 110. The annular structure 110 comprises an outer fairing 100 defining an outer aerodynamic surface and an inner fairing 102 defining an inner aerodynamic surface. The outer fairing 100 and the inner fairing 102 are connected at their upstream ends 104, 106, by the air intake lip 108 forming a leading edge. The air intake lip 108 provides the junction between the two fairings 100, 102 and could be integrated to the outer fairing 100 of the air intake 1. The air intake lip 108 is delimited by a partition 112, called a “front partition,” which forms an annular shaped volume with a “D”-like shaped section. In one aspect, the partition is made of titanium and is fastened to the air intake lip by a fastening flange 113 having an L-like shape. In another aspect, the fastening flange 113 is also made of titanium.

The inner fairing 102 of the air intake 1 comprises an outer skin 114. The outer skin 114 extends from a fan outer casing 116 up to the air intake lip 108. The fan outer casing 116 surrounds a fan 136 comprising fan blades 126. In the present example, one single fan blade is represented.

The fan 136 is designed so as to be rotated. The rotation of the fan 136 drives the fan blades 126 which compress air coming into the turbojet engine.

The outer skin 114 is fastened at its upstream end 106 to the air intake lip 108 by an upstream fastening flange 118 and is fastened at its downstream end 120 to the fan casing 116 by a downstream fastening flange 122. The downstream end 120 of the outer skin 114 may be connected to the inner periphery of a transverse annular partition 124 for reinforcement and load transmission, called a “rear partition,” whose outer periphery is connected to the outer fairing 100 of the air intake 1.

Thus, the outer skin 114 provides the transmission of loads from the air intake lip 108 up to the fan casing 116. The outer skin 114 is structural.

The upstream fastening flange 118 may be integral with the outer skin 114. By integral with, it should be understood that the upstream fastening flange 118 and the outer skin 114 are formed in one piece. In one aspect, the fastening flange and the outer skin are made of a composite material such as dry fibers infused in a thermoplastic resin. The upstream fastening flange 118 and the outer skin 114 may be made by shape forming. Shape forming comprises setting the material to be deformed in place on a first tooling and deforming the material by a second tooling having the desired final shape. This method also allows forming an angle comprised between 80° and 100° between the upstream fastening flange 118 and the outer skin; in one form, the upstream fastening flange 118 forms an angle of 90° with the outer skin 114.

The air intake 1 comprises an independent acoustic panel 2. The acoustic panel 2 comprises a perforated acoustic skin 200. The perforated acoustic skin 200 comprises a plurality of holes (not shown) evenly formed in the acoustic skin 200.

The acoustic panel 2 also comprises a cellular core 202 including a plurality of acoustic cells which are separated from each other by peripheral partitions 204.

FIG. 2 illustrates the air intake 1 for a turbomachine nacelle wherein the acoustic panel 2 is attached to the outer skin 114.

The acoustic panel 2 is attached to the outer skin 114 by fastening flanges 208, 210. By attached acoustic panel, it should be understood a panel manufactured separately from the outer skin 114 of the air intake 1 and which is assembled afterwards on this outer skin 114.

The acoustic panel 2 could be removably fastened on the outer skin 114 to facilitate replacement thereof in case of deterioration.

The acoustic panel 2 extends along the outer skin 114 from the air intake lip 108 up to the fan casing 116. Thus, the acoustic panel 2 is disposed upstream of fan blades 126.

Thus, the structural and acoustic functions are disassociated. The structural function enabling the transmission of loads is provided by the outer skin 114 of the inner fairing which extends from the air intake lip 108 up to the fan casing 116. The acoustic treatment function is provided by the acoustic panel 2 attached to the outer skin 114 by the fastening flanges 208, 210. Because the manufacture of the acoustic panel is independent of the manufacture of the air intake, the making of the acoustic panel is not subjected to the manufacturing constraints of this air intake (in particular to the pressure and temperature constraints).

Thus, the acoustic panel 2 may be made of a metallic material and/or of a composite material. In one form, both the acoustic skin and the cellular core may be made of a metallic material. In another form, the acoustic skin and the cellular core are made of aluminum, and in other forms, the acoustic skin and the cellular core may be made of an aluminum alloy selected in the 6000 series. The metallic cellular core is fastened to the metallic acoustic skin by brazing. The metallic acoustic skin is pierced with a micro-piercing technique carried out by laser.

The use of these different materials is made possible because of the separation of the acoustic and structural functions.

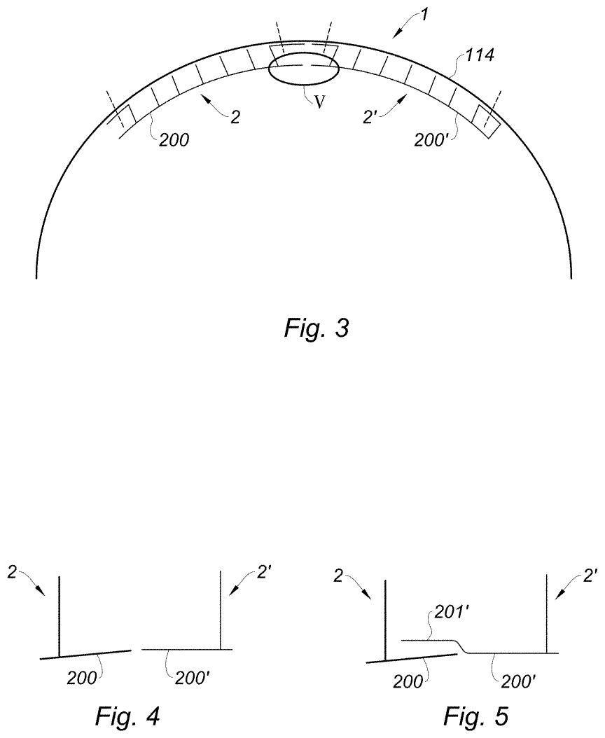

FIG. 3 is a partial view of the air intake in cross-section according to the plane IV-IV of FIG. 2. This figure shows two independent acoustic panels 2, 2′ comprising one perforated skin 200, 200′, respectively, attached to the outer skin 114 and fastened thereon by fastening flanges (not shown).

Although the example of FIG. 3 shows an air intake comprising two acoustic panels attached to the outer skin, it is considered to attach other acoustic panels to cover the entirety of the circumference of the air intake of the nacelle.

FIGS. 4 and 5 are enlarged views of the section V of FIG. 3 which illustrate variants of the form of the air intake illustrated in FIG. 3.

Referring to FIG. 4, the two acoustic panels 2, 2′ are adjacent and connected to one another by juxtaposition, that is to say edge-to-edge.

According to a second variant illustrated in FIG. 5, the acoustic panels 2, 2′ are adjacent and connected together by overlapping.

In this variant, an overlapping strip 201′ of the perforated acoustic skin 200′ of the first acoustic panel 2′ is designed so as to be superimposed with the perforated acoustic skin 200 of the adjacent acoustic panel.

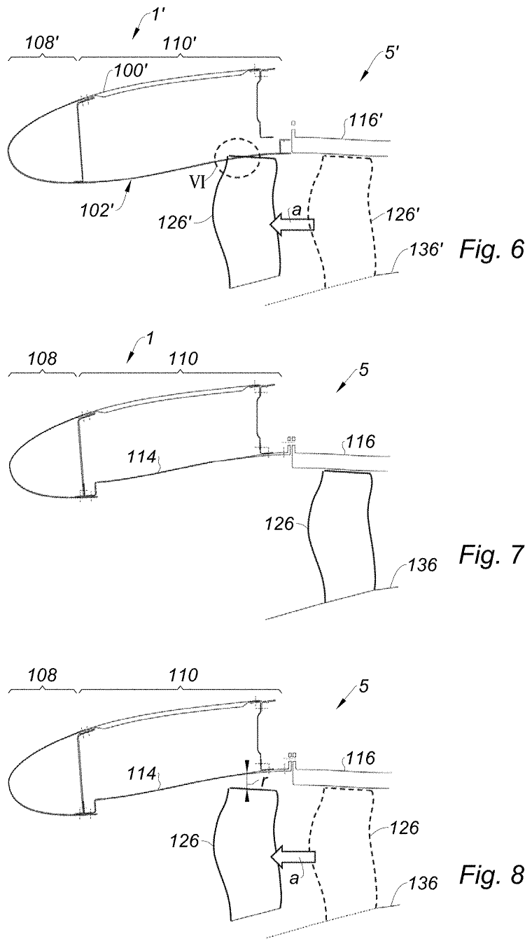

FIG. 6 is an illustration of a propulsion unit 5′ of the prior art on which it is possible to view a deposition of a fan blade 126′. The propulsion unit 5′ comprises a nacelle air intake 1′ and a fan casing 116′ surrounding a fan 136′ including a fan blade 126′. The deposition of the fan blades might be performed for servicing or repairing the fan blades.

The air intake 1′ comprises an air intake lip 108′ and an annular structure 110′.

The annular structure 110′ comprises an outer fairing 100′ defining an outer aerodynamic surface and an inner fairing 102′ defining an inner aerodynamic surface. The air intake 1′ of the nacelle has a substantially frustoconical shape.

The axial translational displacement along the direction of the arrow (a) towards the air intake lip 108′ of the fan blade 126′ causes an interference (represented in section VI) of the blade 126′ with the air intake. This is encountered in particular with short nacelles, which converge in the direction of the air intake lip.

FIGS. 7 and 8 illustrate the deposition of a fan blade 126 of a propulsion unit 5 according to a form of the present disclosure wherein at least one attached acoustic panel has been removed. In the present example, one single acoustic panel 2 has been removed. The propulsion unit 5 has a nacelle air intake 1 including an air intake lip 108 and an annular structure 110, a fan outer casing 116 surrounding a fan 136 including a fan blade 126. FIG. 8 illustrates more particularly the displacement of the fan blade 126 to be deposited in axial translation along the direction of the arrow (a) towards the air intake lip 108.

The air intake of the nacelle having a substantially frustoconical shape, the outer skin 114 of the air intake therefore has a shape diverging from the air intake lip 108 up to the fan blade 126.

The setback of the attached acoustic panel 2 allows forming a radial clearance (r) between the outer skin 114 and the fan blade 126 such that the fan blade 126 does not come into contact with the air intake 1 during its axial translational displacement.

At least one independent acoustic panel 2 is offset from the outer skin 114 to form a radial clearance (r). The fan comprising the fan blades is rotated, for example manually, so as to position the fan blade to be deposited opposite the panel(s) that has/have been deposited and then the fan blade 126 is displaced in translation according to an axial displacement (a) in the direction of the air intake lip 108 allowed by the radial clearance (r). The fan blade 126 does not interfere with the air intake 1 during its displacement in axial translation.

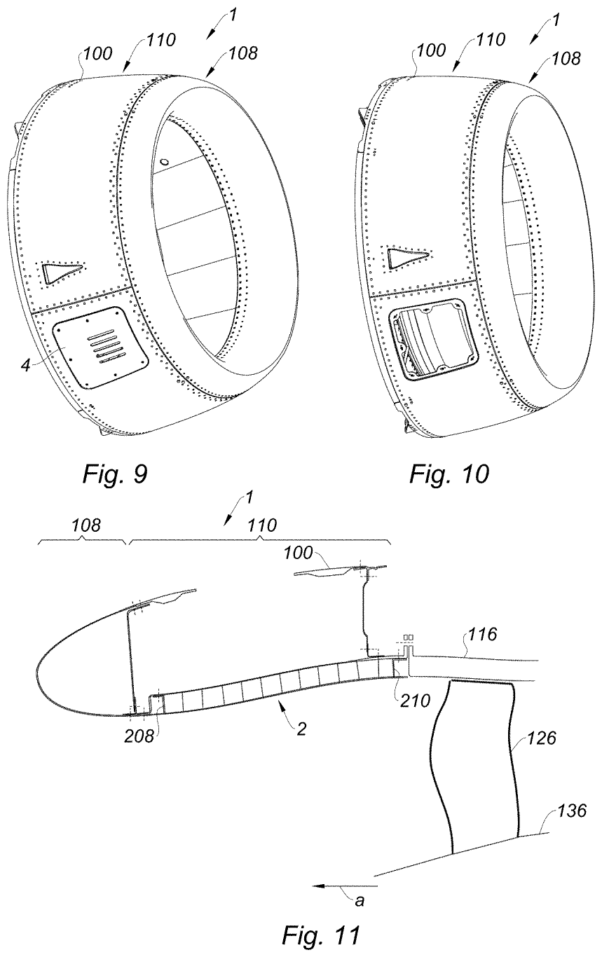

FIG. 9 illustrates an air intake 1 comprising an air intake lip 108 and an annular structure 110 including an outer fairing 100. The annular structure 110 includes a hatch 4 movable between a closed position in which the hatch is flush with the outer fairing 100 and an open position in which the hatch opens access to the acoustic panel 2. The hatch is adapted to be completely removed from the outer fairing 100 (FIG. 10). The removal of the movable hatch allows accessing the acoustic panel without having to deposit the outer fairing of the air intake lip.

The hatch may also be used to provide access to other elements that might be present in the air intake such as elements of a deicing system or probes used for engine monitoring.

FIG. 11 illustrates the air intake 1 of a turbomachine nacelle wherein the hatch 4 has been removed from the annular structure to allow access to the fastening flanges 208, 210 of the acoustic panel 2. The hatch 4 is removed from the outer fairing 100 of the annular structure 110 to allow access to the fastening flanges 208, 210 of an acoustic panel 2 to be removed. The acoustic panel 2 is deposited. The fan 136 comprising the fan blades is rotated so as to position the fan blade to be deposited opposite the deposited acoustic panel. The fan blade 126 to be deposited is displaced by axial translation along the direction of the arrow (a) in the direction of the air intake lip 108 allowed by the radial clearance (r) (FIG. 8). Because of the deposition of the acoustic panel 2, the fan blade 126 does not come into contact with the air intake during deposition thereof.

Thus, because of the air intake according to the present disclosure wherein the acoustic panel is attached rather than structural, maintenance and repair operations are simplified. In addition, it is possible to desirably control the making of the perforations in the acoustic skin so as to limit aerodynamic losses.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. An air intake of a turbojet engine nacelle comprising an annular structure comprising an outer fairing defining an outer aerodynamic surface and an inner fairing defining an inner aerodynamic surface, said outer and inner fairings being connected upstream by an air intake lip forming a leading edge, said inner fairing comprising an outer skin fastened to the air intake lip by an upstream fastening flange, said outer skin configured to be fastened to a fan outer casing by a downstream fastening flange, the air intake comprising at least two independent acoustic panels attached to the outer skin and comprising a perforated acoustic skin and a cellular core, said at least two acoustic panels being adjacent and connected together by overlapping.

2. The air intake according to claim 1, wherein the upstream fastening flange is integral with the outer skin.

3. The air intake according to claim 1, wherein the upstream fastening flange forms an angle in the range of 90° with the outer skin.

4. The air intake according to claim 1, wherein the outer skin is made of a composite material.

5. The air intake according to claim 1, wherein the at least two independent acoustic panels are removably attached to the outer skin.

6. The air intake according to claim 1, wherein the at least two independent acoustic panels are made of a metallic material.

7. The air intake according to claim 6, wherein the cellular core is fastened to the perforated acoustic skin by brazing.

8. The air intake according to claim 1, wherein at least one of the at least two independent acoustic panels comprises an overlapping strip designed so as to be superimposed with the adjacent acoustic panel.

9. The air intake according to claim 1, wherein at least one movable hatch is arranged at a level of the annular structure.

10. A propulsion unit comprising the air intake according to claim 1 and a fan comprising a plurality of fan blades, wherein the outer skin of the air intake on which at least one acoustic panel is attached has a shape diverging from the air intake lip up to the fan blades and the propulsion unit has a radial clearance between the outer skin and the fan blades formed by a setback of at least one acoustic panel.

11. A method for depositing a fan blade of a propulsion unit according to claim 10, the method comprising:
depositing at least one independent acoustic panel attached to the outer skin so as to form a radial clearance; and
translating a fan blade to be deposited according to an axial displacement in a direction of the air intake lip allowed by the radial clearance.

12. The method according to claim 11 further comprising rotating the fan so as to position a fan blade to be deposited opposite the deposited acoustic panel.

13. The method according to claim 11, wherein the acoustic panel is attached to the outer skin by fastening flanges, and wherein the method further comprises removing a movable hatch from an annular structure to access the fastening flanges of the acoustic panel.
